(19) United States
(12) Patent Application Publication
(10) Pub. No.: US 2016/0280352 A1
(43) Pub. Date: Sep. 29, 2016

(54) METHOD OF COLLECTING DATA IN BALLAST WATER TREATMENT SYSTEM AND SYSTEM FOR ANALYZING SHIP BALLAST WATER TREATMENT BIG DATA USING MOBILE COMMUNICATION NETWORK

(71) Applicant: HANLA IMS CO., LTD., Busan (KR)

(72) Inventors: Suk Joon Ji, Busan (KR); Young Gu Kim, Busan (KR); In Tae Cho, Busan (KR); Woo Jin Choi, Gyeongsangnam-do (KR); Kwang Seob Lee, Busan (KR); Chae Ho Lee, Busan (KR); Chang Kook Kim, Busan (KR)

(73) Assignee: HANLA IMS CO., LTD., Busan (KR)

(21) Appl. No.: 14/890,100

(22) PCT Filed: Nov. 13, 2014
(86) PCT No.: PCT/KR2014/010884

§ 371 Date: Nov. 9, 2015

(30) Foreign Application Priority Data
Oct. 31, 2014 (KR) 10-2014-0150153

(51) Int. Cl. B63J 4/00; G05B 15/02; H04L 29/08

(52) U.S. Cl. CPC B63J 4/002; H04L 67/12; G05B 15/02

(57) ABSTRACT

Disclosed are a system for analyzing ship ballast water treatment big data using a mobile communication network, the system including: a ship ballast water treatment controller installed in a ship side to record and store operation information of the ballast water treatment system in the ship; a mobile communication network connector installed in the ship side to detects a mobile communication network connectable area from a ship running area, to perform automatic call connection when the ship reaches the mobile communication network connectable area, connects with the ship ballast water treatment controller through the internal communication repeater to transmit the information operation information of the ballast water treatment system recorded in the ship ballast water treatment controller to a ship ballast water operation server in an external internet, and to receive operation and maintenance information of the ballast water treatment system from the ship ballast water operation server; a ship ballast water treatment big data analyzer installed at a ground maker side base to connect with the ship ballast water treatment operation server to collect the operation information of the ballast water treatment system when the ship runs, and to analyze and manage the operation information of the BWTS as big data, and to store the big data in the ship ballast water treatment operation server, wherein the system automatically collects the operation information of the ballast water treatment system of marine running ship to analyze and treat the collected operation information of the ballast water treatment system as big data, remotely monitors and checks state information of the ballast water treatment system of the overall marine running ship to manage the overall marine running ship in an optimal state and a method of collecting data in a ballast water treatment system.

### BACKGROUND OF THE INVENTION

1. Field of the Invention

The present invention relates to a method of collecting data in a ballast water treatment system (hereinafter referred to as ‘BWTS’) and a system for analyzing ship ballast water treatment big data using a mobile communication network that automatically collect operation information of a BWTS of the entire marine running ships to analyze and treat the collected operation information of the BWTS as big data, remotely monitor and check state information of the BWTS of the entire marine running ships to manage the entire marine running ships in an optimal state.

In this case, in order to avoid confusion of terms, terms described in the specification are defined as follows. The BWTS is installed in a ship. A mechanical constituent element for controlling ballast water of a ship is defined as BWTS in the ship. A constituent element for automatically controlling the BWTS 100 and receiving various sensor information is defined as a ballast water treatment controller 110.

2. Related Art

In general, the BWTS is a device for controlling ballast water filled in a ballast tank of a ship. The ballast water filled in the ballast tank of the ship includes various marine creatures and pathogens. When marine creatures or pathogens in a specific sea area are introduced into another sea area so that adverse reaction disturbing an environment and an ecosystem is caused.

Accordingly, International maritime organization (IMO) performs a procedure of purifying and sterilizing the marine creatures or the pathogens in the ballast water when the ballast water is introduced and discharged. The IMO legislates strict agreement of regulations including prohibition of arrival of a ship in port when the reference is not satisfied.

Accordingly, the BWTS is necessarily installed. Since a ship driver does not have professional technical knowledge to the BWTS, a professional operation method of the BWTS in the ship becomes a technical problem to be solved.

For the purpose of BWTS operation and safe management in the ship, a remote management type BWTS by augmented reality is disclosed in Korean patent No. 10-1354133.

However, the Korean patent No. 10-1354133 transmits operation information of the BWTS through an artificial satellite during a marine running of the ship. Since a cost is very high to provide information using the artificial satellite, the artificial satellite is not satisfied as a sufficient information transmission device.

Meanwhile, the BWTS is generally operated when a ship arrives in a port or departs from the port, operation information of the BWTS is created in a port neighboring location. If there is operation information to be applied to the BWTS, the operation information is applied when the ship is located close to the port.

In view of the above, it is expected that the BWTS is operated in an external connectable state using a wireless mobile communication network always installed in the port.

However, since types and schemes of the wireless mobile communication network are different from each other according to nations, it is difficult to configure the device. If the BWTS is connected to wireless mobile communication network in all the nations in which the ship runs, a communication cost is exponentially increased so that a cost is increased as compared with a satellite communication.

In the meantime, in view of the entire ships running the sea, destination marine information and BWTS optimal operation information of a ship which currently runs may be recognized as information recorded in a ship now running a corresponding destination to be created.

However, in a present ship navigation system, since the BWTS information of each ship is in interrupted and independent state, the information created from each ship does not have a chance to be processed as big precious information to the entire marine running ships.

### SUMMARY OF THE INVENTION

The present invention has been made in view of the above problems, and provides a method of collecting data in a BWTS and a system for analyzing ship ballast water treatment big data using a mobile communication network that simultaneously collect BWTS operation information of each ship in a zone in which a wireless mobile communication is possible to process big data and create and process the big data as BWTS operation information of the entire marine running ships.

In order to accomplish the above object, in accordance with an aspect of the present invention, there is provided a system for analyzing ship ballast water treatment big data using a mobile communication network, the system including: a ship ballast water treatment controller installed in a ship side to record and store operation information of the ballast water treatment system in the ship; a mobile communication network connector installed in the ship side to detects a mobile communication network connectable area from a ship running area, to perform automatic call connection when the ship reaches the mobile communication network connectable area, connecting with the ship ballast water treatment controller 110 through the internal communication repeater to transmit the information operation information of the ballast water treatment system recorded in the ship ballast water treatment controller to a ship ballast water operation server in an external internet, and to receive operation and maintenance information of the ballast water treatment system from the ship ballast water operation server; a ship ballast water treatment big data analyzer installed at a ground maker side base to connect with the ship ballast water treatment operation server to collect the operation information of the ballast water treatment system when the ship runs, and to analyze and manage the operation information of the BWTS as big data, and to store the big data in the ship ballast water treatment operation server, wherein the system automatically collects the operation information of the ballast water treatment system of marine running ship to analyze and treat the collected operation information of the ballast water treatment system as big data, remotely monitors and checks state information of the ballast water treatment system of the overall marine running ship to manage the overall marine running ship in an optimal state.

The mobile communication network connector may include a wireless internet communication network connected with an external internet when a marine running ship approaches a port.

In accordance with another aspect of the present invention, there is provided a method of collecting data in a ballast water treatment system using a mobile communication network, the method including: a first step of recording and storing operation information of the ballast water treatment system by the ship ballast water treatment controller which is installed at a ship side; a second step of detecting a mobile communication network connectable area from a ship running area by a mobile communication network connector installed in the ship side, automatically connecting with a marine running ship after a network state checking procedure when the marine running ship reaches the mobile communication network connectable area after the marine running ship approaches a port, and performing Internet connection by a ship ballast water operation server on an external internet; a third step is a step of transmitting the operation information of the BWTS recorded in the ship ballast water treatment controller of the first step to the ship ballast water operation server in the external internet, and receiving operation and maintenance information of the BWTS by the ship ballast water operation server; a fourth step of internet-connecting with the ship ballast water operation server by a ship ballast water treatment big data analyzer installed at a ground maker side base to collect operation information of the ballast water treatment system when the ship runs, creating operation information and maintenance information of the by analyzing the collected operation information of the ballast water treatment system as big data together with operation information of the ballast water treatment system of the overall marine ship, and storing the created operation information and maintenance information of the ballast water treatment system to provide the created operation information and maintenance information to a corresponding ship, wherein the method automatically collects the operation information of a ballast water treatment system of the overall marine running ship to analyze big data, to create and provide the operation information of the ballast water treatment system of a running ship.

### Advantageous Effects

In accordance with the present invention, provided are a method of collecting data in a BWTS and a system for analyzing ship ballast water treatment big data using a mobile communication network that simultaneously collect BWTS operation information of each ship in a zone in which a wireless mobile communication is possible to process big data and create and process the big data as BWTS operation information of the entire marine running ships.

### BRIEF DESCRIPTION OF THE DRAWINGS

FIG. 1 is a block diagram of the present invention

FIG. 2 is a another block diagram of the present invention

### DESCRIPTION OF REFERENCE NUMERAL

10: Ship 20: Ship ballast water operation server

30: Ship ballast water treatment big data analyzer 40: Mobile communication base station

100: BWTS 110: Ship ballast water treatment controller

120: Internal communication repeater 130: Mobile communication network connector

### DESCRIPTION OF EXEMPLARY EMBODIMENTS

The above objects, features, and advantages can be more clearly comprehended through the following description in relation to accompanying drawings. Accordingly, those skilled in the art can easily realize the present inventive concept. In the following description, if detailed description about well-known functions or configurations may make the subject matter of the disclosure unclear, the detailed description will be omitted.

Terms and words used in the specification and the claims shall not be interpreted as commonly-used dictionary meanings, but shall be interpreted as to be relevant to the technical scope of the invention based on the fact that the inventor may define the concept of the terms to explain the invention in best ways.

In addition, in order to avoid confusion of terms, terms described in the specification are defined as follows. The BWTS is installed in a ship. A mechanical constituent element for controlling ballast water of a ship is defined as BWTS in the ship. A constituent element for automatically controlling the BWTS 100 and receiving various sensor information is defined as a ballast water treatment controller 110.

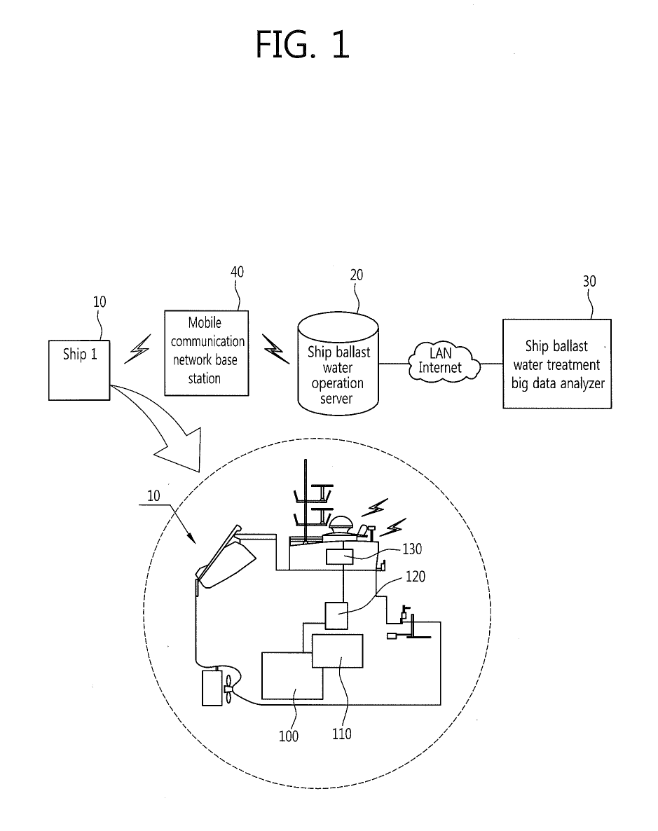

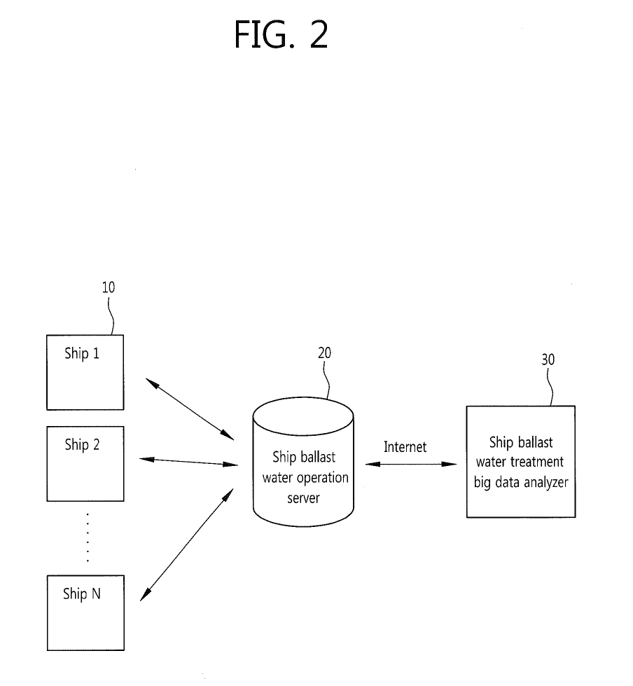

FIG. 1 is a block diagram of the present invention. FIG. 2 is another block diagram of the present invention.

As shown, the a system for analyzing and providing ship ballast water treatment big data according to the present invention includes a BWTS 100, a ship ballast water treatment controller 110, and a mobile communication network connector 130 installed in a ship 10 side, a ship ballast water operation server 20, a ship ballast water treatment big data analyzer 30.

The present invention relates to a system for analyzing and providing ship ballast water big data including the above constituent elements to provide operation information and management information of the BWTS 100 with respect to an area in which each ship runs by collecting data with respect to the BWTS 100 in a ship running all over the world.

Accordingly, the apparatus of collecting data in a BWTS and a system for analyzing and providing ship ballast water treatment big data using a mobile communication network are configured by the present invention. Hereinafter, the system by steps and the apparatus will be simultaneously described in view of the system for analyzing ship ballast water treatment big data.

A first step of the method of collecting data in a BWTS is a step of recording and storing operation information of the BWTS 100 by the ship ballast water treatment controller 110 which is installed at the ship 10 side.

As shown in FIG. 1, the ship ballast water treatment controller 110 is installed in the ship 10 side, and records and stores the operation information of the BWTS 100 in the ship 10.

The BWTS is installed in a ship. A mechanical constituent element for controlling ballast water of a ship is defined as BWTS in the ship. A constituent element for automatically controlling the BWTS 100 and receiving various sensor information is defined as a ballast water treatment controller 110.

The BWTS of the ship is operated when the ship arrives in a port or departs from the port and maintains the balance of the ship. The operation information is recorded and stored in the ship ballast water treatment controller 110, and the operation information includes optimal control information for producing sodium hypochlorite in the apparatus and analyzing and efficiently managing pollutant material removal performance of filter and the like.

A second step of the method of collecting data in a BWTS is a step of detecting a mobile communication network connectable area from a ship running area by the mobile communication network connector 130 installed in the ship 10 side, automatically connecting with a marine running ship after a network state checking procedure when the marine running ship reaches a mobile communication network connectable area after the marine running ship approaches a port, and performing Internet connection by a ship ballast water operation server 20 on an external internet. A third step is a step of transmitting the operation information of the BWTS recorded in the ship ballast water treatment controller 110 of the first step to the ship ballast water operation server 20 in the external internet, and receiving operation and maintenance information of the BWTS by the ship ballast water operation server 20.

The mobile communication network connector 130 is a device installed in the ship 10 side, and detects the mobile communication network connectable area from the ship running area, and performs automatic call connection when the ship reaches the mobile communication network connectable area.

The mobile communication network connector 130 is a wireless communication device which may communicate with a harbor mobile communication base station 40. The mobile communication network connector 130 includes a WCDMA (3G, 4G, LTE network) device, a GSM device or a WIFI device.

According to the present invention, the mobile communication network connector 130 includes a known technical content connected to a wireless internet connection environment to be connected with the internet or a mobile communication network.

That is, an environment capable of connecting with a wireless internet environment such as a broadband Wi-Fi or WiBro through the internet or the mobile communication network to transmit/receive data may be selected as a desired design level.

As shown in FIG. 1, the mobile communication network connector 130 according to the present invention connects with the ship ballast water treatment controller 110 through the internal communication repeater 120 and transmits and receives information recorded in the ship ballast water treatment controller 110.

In general, mobile communication networks by nations are installed to have a characteristic, respectively. It is most preferable that the mobile communication network connector 130 is connected with all the mobile communication network connectors of all nations of the world and communicates with in a communication method according to a port which allows the ship to be brought alongside. In real application, it is difficult to configure the device and operation and communication costs of the device are inevitably increased.

Accordingly, the present invention selects a specific nation having an easy internet connection with mobile communication. The present invention selects the mobile communication network connector 130 suitable for a mobile communication method of a corresponding nation to be installed.

For example, 3G and 4G mobile communication devices included in Korean standard call methods are installed as the mobile communication network connector 130. If the ship 10 runs the harbors in the world and approaches a harbor in Korea and reaches a mobile communicable area, the mobile communication network connector 130 checks a connection network state in a mobile communication base station 40 close to the harbor to automatically connect and performs call connection.

In this case, the mobile communication network connector 130 is configured by a device automatically internet-connecting with the ship ballast water operation server 20 which is externally installed in a mobile communicatable area. The mobile communication network connector 130 automatically transmits the operation information of the BWTS recorded in the ship ballast water treatment controller 110 to the ship ballast water operation server 20 on the external internet.

That is, the mobile communication network connector 130 is an automatic telephone device for selecting a mobile communication network in a specific nation such as U.S.A., Japan, and Korea among nations in the world having easy internet connection through telephone call. The mobile communication network connector 130 is a device for automatically transmitting/receiving storage information of the ship ballast water treatment controller 110.

The selected number of national communication networks may become a plurality of specific nations selected by taking into consideration one nation or cost.

Accordingly, if the ship 10 according to the present invention is brought alongside the port of each nation, stores and manages operation information of the BWTS 100, and reaches a nation (e.g., Korea) which may call the telephone and connects mobile communication, the mobile communication network connector 130 transmits all the operation information of the BWTS 100 stored to the ship ballast water operation server 20 through internet of mobile communication, and receives the operation information of the BWTS 100 from the ship ballast water operation server 20.

A fourth step of the method of collecting data in a BWTS is a step of internet- connecting with the ship ballast water operation server 20 by the ship ballast water treatment big data analyzer 30 installed at a ground maker side base to collect operation information of the BWTS upon running the ship, creating operation information and maintenance information of the BWTS by analyzing the collected operation information of the BWTS as big data together with operation information of the BWTS of the entire marine ships as shown in FIG. 2, and storing the created operation information and maintenance information of the BWTS to provide the created operation information and maintenance information to a necessary ship 10.

That is, the ship ballast water treatment big data analyzer 30 of the present invention is installed at the ground maker side base, and connects with the ship ballast water treatment operation server 20 to collect the operation information of the BWTS when the ship 10 runs and to analyze and manage the operation information of the BWTS as big data, and to store the big data in the ship ballast water treatment operation server.

The big data means a large amount of formal or informal data group capable of collecting, storing, managing, and analyzing data by an existing database management tool and a technology of extracting a value from the data group to analyze a result. Big data analysis technology and method include data mining, mechanical leaning, nature language processing, pattern recognition, and the like which is used in an existing statistics and computer science.

The development of the big data technology capable of generating, collecting, analyzing, and expressing various type of a large amount of data realizes a technology that exactly and efficiently estimates and operates various current society and provides, manages, and analyzes customized information of a current society private members.

The above big data represents possibility capable of providing valuable information to a society and a human being through all fields such as politics, society, culture, and science technology, and the importance thereof has been spotlighted.

In the present invention, as shown in FIG. 2, if the ships including the apparatus according to the present invention wander the world, operates the BWTS 100 to record the information and reaches an internet connection possible area, the device transmit an operation information of the BWTS 100 to the ship ballast water operation server 20.

The information of each ship becomes big data in the ship ballast water operation server 20, and the ship ballast water treatment big data analyzer 30 analyzes the big data and transfers analysis information to a ship reaching a call possible area as the operation information of the BWTS 100.

The operation information includes concentration analysis and filter optimal operation information by marine conditions of each nation such as Korea, Japan, and Hong Kong in which the ship will run, sodium hypochlorite production information, pollutant material removal performance analysis and efficiency management information, and optimal operation control information for expecting and removing danger elements.

Accordingly, the present invention provides a method of collecting data in a BWTS and a system for analyzing ship ballast water treatment big data using a mobile communication network that record and store a marine state by ports when each ship 10 runs the sea in the world, concentrate and collect the stored information in the ship ballast water operation server 20 to form big data as the operation information of each BWTS 200 of the world sea area, and analyze the big to provide the analyzed big data as the operation information of the BWTS 100.

Various example embodiments will be described more fully hereinafter with reference to the accompanying drawings, in which some example embodiments are shown. The present inventive concept may, however, be embodied in many different forms and should not be construed as limited to the example embodiments set forth herein.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. A system for analyzing ship ballast water treatment big data using a mobile communication network, the system comprising:
a ship ballast water treatment controller installed in a ship side to record and store operation information of the ballast water treatment system in the ship;
a mobile communication network connector installed in the ship side to detects a mobile communication network connectable area from a ship running area, to perform automatic call connection when the ship reaches the mobile communication network connectable area, connecting with the ship ballast water treatment controller through the internal communication repeater to transmit the information operation information of the ballast water treatment system recorded in the ship ballast water treatment controller to a ship ballast water operation server in an external internet, and to receive operation and maintenance information of the ballast water treatment system from the ship ballast water operation server;
a ship ballast water treatment big data analyzer installed at a ground maker side base to connect with the ship ballast water treatment operation server to collect the operation information of the ballast water treatment system when the ship runs, and to analyze and manage the operation information of the BWTS as big data, and to store the big data in the ship ballast water treatment operation server, wherein the system automatically collects the operation information of the ballast water treatment system of marine running ship to analyze and treat the collected operation information of the ballast water treatment system as big data, remotely monitors and checks state information of the ballast water treatment system of the overall marine running ship to manage the overall marine running ship in an optimal state, wherein, in the ballast water treatment system installed in the ship, a mechanical constituent element for controlling ballast water of a ship is defined as a ballast water treatment system 100, and a constituent element for automatically controlling the ballast water treatment system 100 and receiving various sensor information is defined as the ballast water treatment controller 110.

2. The system of claim 1, wherein the mobile communication network connector comprises a wireless internet communication network connected with an external internet when a marine running ship approaches a port.

3. A method of collecting data in a ballast water treatment system using a mobile communication network, the method comprising:
a first step of recording and storing operation information of the ballast water treatment system by the ship ballast water treatment controller which is installed at a ship side;
a second step of detecting a mobile communication network connectable area from a ship running area by a mobile communication network connector installed in the ship side, automatically connecting with a marine running ship after a network state checking procedure when the marine running ship reaches the mobile communication network connectable area after the marine running ship approaches a port, and performing Internet connection by a ship ballast water operation server on an external internet;
a third step is a step of transmitting the operation information of the BWTS recorded in the ship ballast water treatment controller of the first step to the ship ballast water operation server in the external internet, and receiving operation and maintenance information of the BWTS by the ship ballast water operation server;
a fourth step of internet-connecting with the ship ballast water operation server by a ship ballast water treatment big data analyzer installed at a ground maker side base to collect operation information of the ballast water treatment system when the ship runs, creating operation information and maintenance information of the by analyzing the collected operation information of the ballast water treatment system as big data together with operation information of the ballast water treatment system of the overall marine ship, and storing the created operation information and maintenance information of the ballast water treatment system to provide the created operation information and maintenance information to a corresponding ship,
wherein the method automatically collects the operation information of a ballast water treatment system of the overall marine running ship to analyze big data, to create and provide the operation information of the ballast water treatment system of a running ship,
and, wherein, in the ballast water treatment system installed in the ship, a mechanical constituent element for controlling ballast water of a ship is defined as a ballast water treatment system 100, and a constituent element for automatically controlling the ballast water treatment system 100 and receiving various sensor information is defined as the ballast water treatment controller 110.
